(19) United States
(12) Patent Application Publication
(10) Pub. No.: US 2016/0183691 A1
(43) Pub. Date: Jun. 30, 2016

(54) SUPPORT ELEMENT

(71) Applicant: Technogel Italia S.r.l., Pozzoleone (VI) (IT)

(72) Inventor: Matteo Mason, Limena (Padova) (IT)

(21) Appl. No.: 14/599,024

(22) Filed: Jan. 16, 2015

(30) Foreign Application Priority Data
Dec. 30, 2014 (IT) VR2014A000316

(51) Int. Cl. A47C 27/08; B29C 39/02; A47G 9/10; A47C 31/10; A47C 27/15

(52) U.S. Cl. CPC A47C 27/085; A47C 31/105; A47C 27/15; A47G 9/10; B29C 39/025; A47G 2009/1018; B29L 2009/005

(57) ABSTRACT

The present invention concerns a support element for the manufacturing of pillows, mattresses, toppers and the like, including at least one base layer having at least one upper, in use, support face, and at least one resting portion; a plurality of gel inserts supported by such at least one support face of such at least one base layer spaced apart from one another; at least one coating layer or film applied on top of such a plurality of gel inserts and such a support face, not affected by such a plurality of gel inserts. At such at least one resting portion, each gel insert of the plurality of gel inserts has a greater average thickness than the average thickness of each gel insert of the plurality of gel inserts arranged outside such at least one resting portion.

### TECHNICAL FIELD OF THE INVENTION

The present invention relates to a support element for the manufacturing of pillows, mattresses, toppers and seat tops.

In particular, the present invention relates to a support element, capable of supporting a user, seated, lying down, resting, etc., providing a high degree of comfort.

The present invention further relates to a method of manufacturing such a support element.

### STATE OF THE ART

In the state of the art various types of support elements for manufacturing pillows, mattresses, toppers and seat tops are known.

Such support elements can be made with conventional materials, in other words foams of various origin, latex, natural materials such as wool, cotton, feathers, etc. In the vast majority of cases, the conventional support elements are enclosed in a fabric casing, synthetic or natural, or by other suitable materials, which have desired characteristics of a nice appearance.

In addition or alternatively, such support elements can comprise a layer made from gel material given, for example, by the reaction of polyols and polyisocyanates and used for various applications, particularly in elements capable of distributing the pressure exerted on them.

Gel, as it is known, has mechanical characteristics capable of allowing suitable support and three-dimensional distribution of the weight of a user, making the element on which the gel itself is applied or in which it is comprised comfortable.

Such a gel layer is usually coupled with a layer of expanded foam of uniform thickness, also in order to reduce the overall weight of the product and lower its production costs.

EP-1 060 859 teaches a method for forming seat tops or similar provided with a uniform layer of gel at a surface intended, in use, to come into contact with a user. The layer of gel also covers the side walls of the seat top.

US 2004/0098806, on the other hand, teaches a shaped body, able to be used to make seat tops, wherein a foam layer is arranged on top of a gel layer and wherein between the gel layer and the foam layer expansion channels are comprised.

Patent application VR2011A000206 describes obtaining through openings in a support element through die cutting.

Products made with gel suffer, however, from the drawback of having a high weight, for which reason they are usually heavier than conventional products. The cost of gel, moreover, has an impact on the total cost of the product, with the consequence that, compared to conventional products, products comprising gel are more expensive.

Therefore, the need is felt to provide support elements for the manufacturing of pillows, mattresses, toppers and seat tops, which are alternatives to those currently available on the market and wherein, at the same time, the drawbacks described above are eliminated or at least reduced to the minimum.

### SUMMARY OF THE INVENTION

The main object, therefore, of the present invention is to improve the state of the art in the field of support elements for the manufacturing of pillows, mattresses, toppers and seat tops.

Another object of the present invention is to provide a support element that provides adequate support to a user, whilst still limiting as much as possible the amount of gel used.

A further object of the present invention is to provide a support element that is easy to make at competitive costs.

Yet another object of the present invention is to provide a method for manufacturing a support element that is easy to implement.

According to a first aspect of the present invention a support element is provided according to aspects of the present principles.

According to another aspect of the present invention a method for manufacturing a support element is provided according to aspects of the present principles.

Further and advantageous features are described in the present specification.

### BRIEF DESCRIPTION OF THE DRAWINGS

The characteristics and advantages of the present invention will also become clearer from the detailed description of some preferred embodiments of a support element, illustrated by way of example but not limiting purposes, in the attached tables of drawings, wherein:

FIG. 1 is a perspective view, slightly from above, of a support element according to a first embodiment of the present invention;

FIG. 1a shows a longitudinal section view, taken along line Ia-Ia, of the support element of FIG. 1;

FIG. 2 illustrates a plan view of a support element according to a second embodiment of the present invention;

FIG. 2a is a cross section view of the element of FIG. 2, taken along the section line IIa-IIa;

FIG. 3 illustrates a plan view of a support element according to the third embodiment of the present invention;

FIGS. 3a, 3b and 3c respectively show sections (slices) of the support element of FIG. 3, taken, respectively, on the section lines IIIa-IIIa, IIIb-IIIb and IIIc-IIIc of FIG. 3;

FIGS. 3d and 3e each illustrate a cross section view taken, respectively, along the section lines IIIa-IIIa and IIIc-IIIc;

FIG. 4 is a plan view of a support element according to the fourth embodiment of the present invention;

FIGS. 4a, 4b and 4c respectively show sections (slices) of the support element of FIG. 4, taken, respectively, on the section lines IVa-IVa, IVb-IVb and IVc-IVc of FIG. 4; and

FIGS. 4d and 4e each illustrate a cross section view taken, respectively, along the section lines IVa-IVa and IVc-IVc;

In the attached drawings the same parts or components are marked with the same reference numerals.

### DETAILED DESCRIPTION OF THE INVENTION

With reference, therefore, to the attached figures, it can be seen how a support element according to the present invention is generally indicated with reference numeral 1 and comprises at least one base layer 2, having at least one support face 3, facing, in use, a user and at least one resting portion 4, foreseen to bear in use an external force of greater intensity than the external force foreseen to be applicable on the base layer 2 outside (external to) such a resting portion 4.

Typically, the external force that in use acts on a support element according to the present invention is the weight force of a person, who sits, lies downrests, on the support element itself.

The arrangement of the resting portion 4 on the base layer 2, therefore, depends on the configuration of the base layer itself. Typically, therefore, the resting portion 4 is defined by a substantially central portion of the base layer 2, when the support element 1 is a mattress, a topper, a seat top or a pillow. In the case of anatomical pillows, however, such a resting portion 4 can also be a peripheral portion, as will become clearer hereafter.

The base layer 2 is made of polyurethane foam.

The support element 1 according to the invention comprises at least one gel insert 5, supported by the support face 3 of the base layer 2. The support face 3 of the base layer 2 not affected by the gel insert or inserts 5 and the top surface of the gel insert(s) 5, opposite the base layer 2, define a contact surface, in use, with the user.

The gel insert(s) 5 supported by the support face 3, as will be described more clearly hereafter, can have different configurations. In any case, however, it/they has/have an average thickness, at the resting portion 4 of the base layer 2, that is greater than the average thickness that it/they has/have outside of or externally to such a resting portion 4. In the specific case in which a plurality of gel inserts 5 are foreseen, each gel insert 5, at the resting portion 4 of the base layer 2, has greater average thickness than the average thickness of each gel insert 5 outside of or externally to such a resting portion 4.

The gel that makes up the insert 5 of the support element 1 according to the invention comprises a polyurethane gel with hardness D′ calculated as Shore 00 equal to zero. More particularly, the gel has a hardness D′ calculated as Shore 000 less than 60.

In a version of the present invention, the gel has a hardness D′ comprised between 0.5 and 100 kPa and hysteresis of about 40%±10% (according to standard ISO 3386-1) so as to give a high degree of comfort, both objective and subjective, for the user. Therefore, this is a very soft gel.

The gel of the gel layer 5 is also compact and very elastic, capable of deforming three-dimensionally when subjected to an external force. The layer of gel 5 can be at least partially transparent or covering and, if desired, it can be variously coloured.

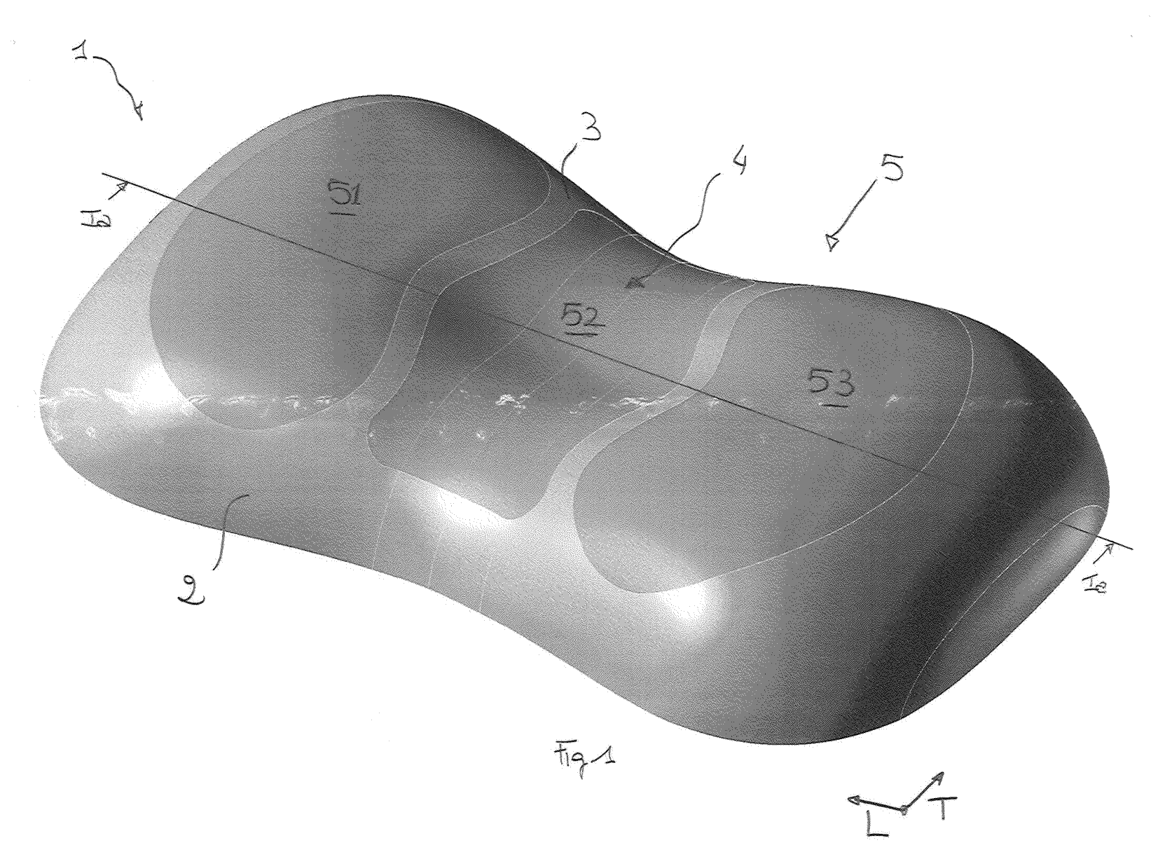

So, FIGS. 1 and 1a provide a representation of a support element according to a first embodiment of the present invention.

The support element 1 is shaped like a pillow and comprises a base layer 2 supporting a plurality of gel inserts 5.

In the figures three (3) gel inserts 5 are show, indicated with reference numerals 51, 52, 53, supported by the base layer 2 a distance apart from one another along a longitudinal axis Ia-Ia of the pillow.

The base layer 2 has a support face 3 and comprises a substantially central resting portion 4, foreseen to bear, in use, an external force of greater intensity than that foreseen at the other portions of the base layer 2 externally to the resting portion 4. Such an external force of greater intensity is, specifically, the weight force of a user's head. Given the configuration of the pillow illustrated in FIGS. 1 and 1a, it is clear that a correct use of the pillow requires that the resting portion 4 is central.

At the central resting portion 4, in the base layer 2 at least one housing seat 6 is formed for a gel insert 5. In the example depicted three housing seats 61, 62 and 63 are foreseen, each for a respective gel insert 51, 52 and 53. So, according to the invention, the gel insert 52, at the central resting portion 4 of the base layer 2, has a greater average thickness than that of the inserts 51 and 53 outside such a resting portion 4.

In the specific example illustrated, each gel insert 51, 52 and 53 has a constant thickness. Those skilled in the art, however, will note how other configurations of the gel insert 5 are possible, provided that at the resting portion 4, the average thickness of the gel is greater than the thickness of the gel inserts outside of such a portion 4.

Going back to the housing seats 61, 62, and 63, they are formed in the base layer 2 in bas-relief and thus being recessed for a constant segment P1, P2 and P3 in each seat. In each housing seat 61, 62, and 63, the layers of gel 51, 52 and 53 each have constant thickness equal to the respective recessed segment P1, P2 and P3 of the respective housing seat, so that they delimit, with the support face 3 of the base layer 2 not affected by the gel, a continuous surface for making contact, in use, with the user.

The support face 3 of the base layer 2 has a substantially undulating profile and, more specifically it comprises a concave segment comprised between two convex segments. At the resting portion 4 the support face 3, and therefore the respective housing seat 62, is substantially concave. In the convex segments of the support face 3, similarly, the housing seats 61 and 63 are convex.

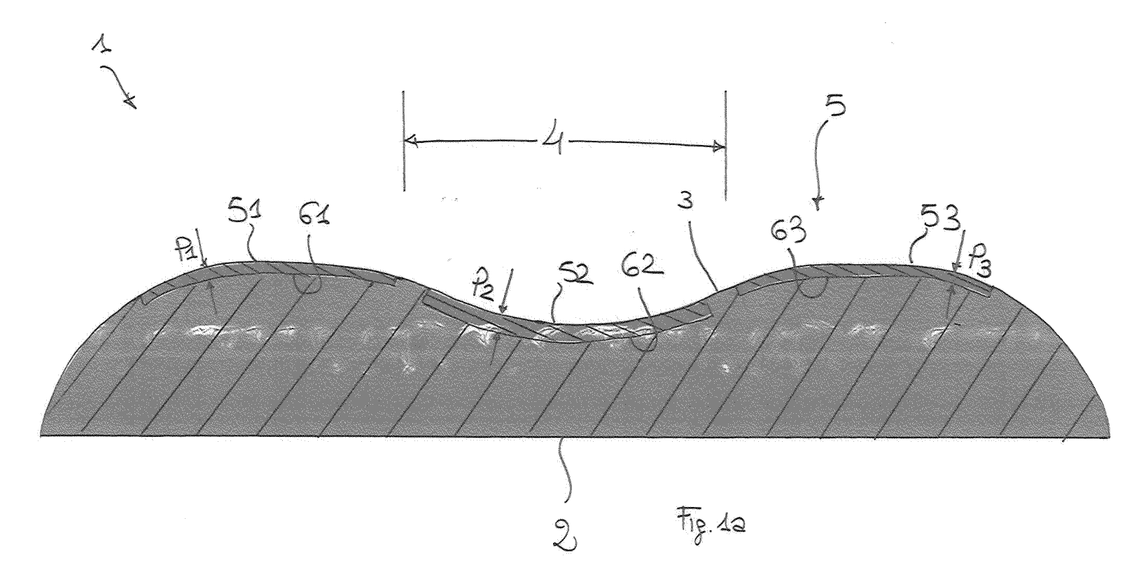

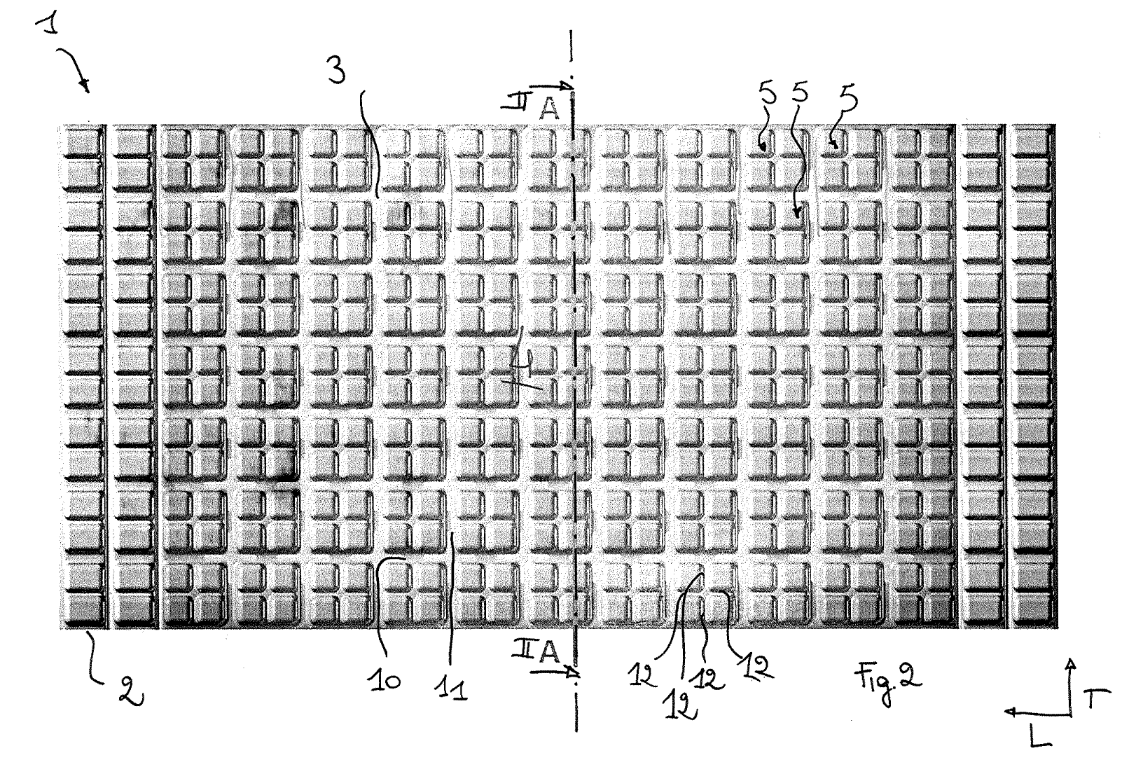

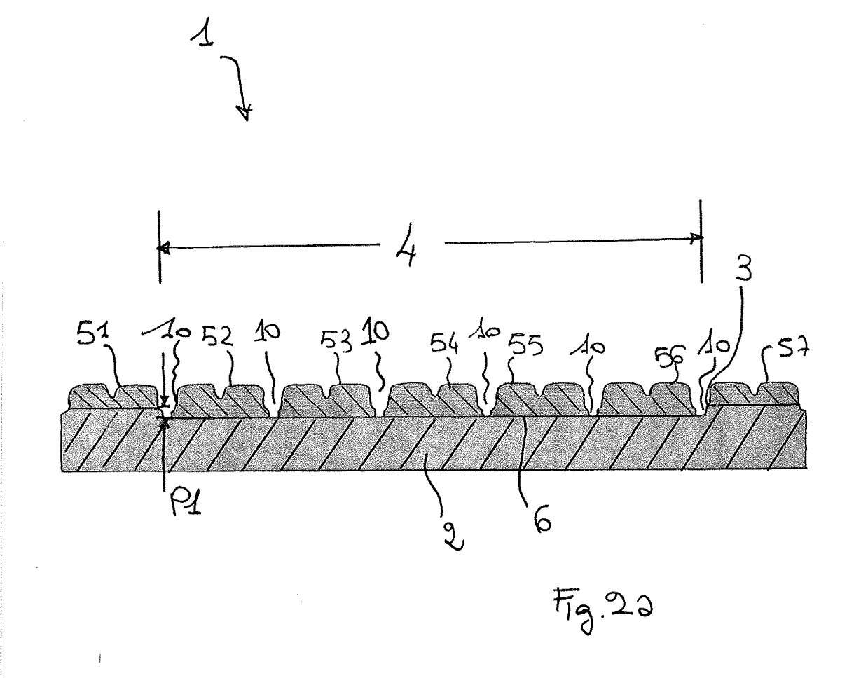

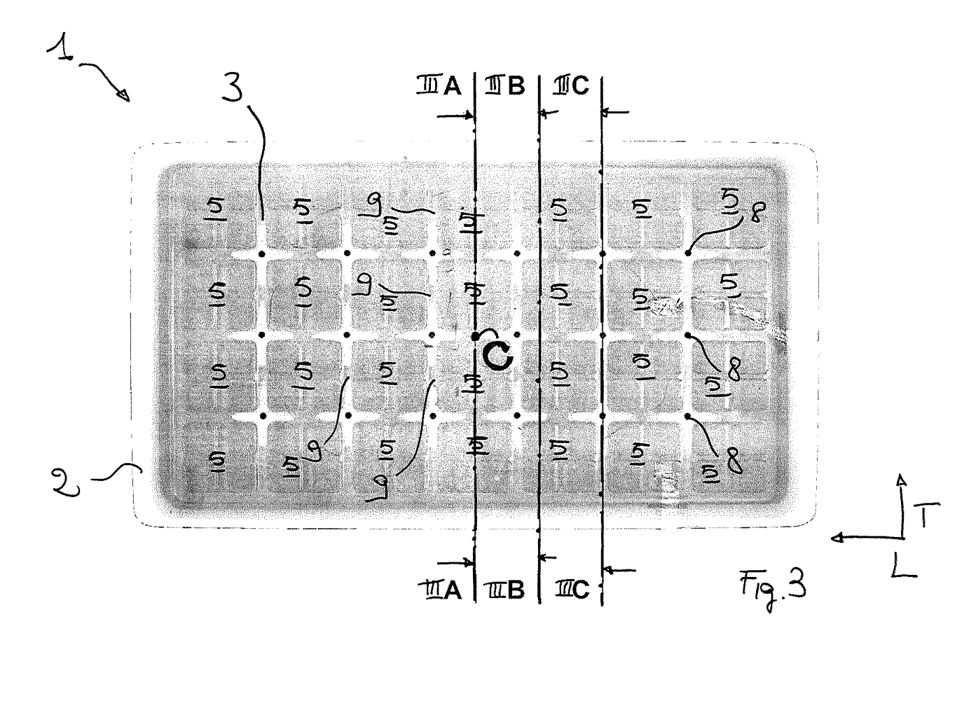

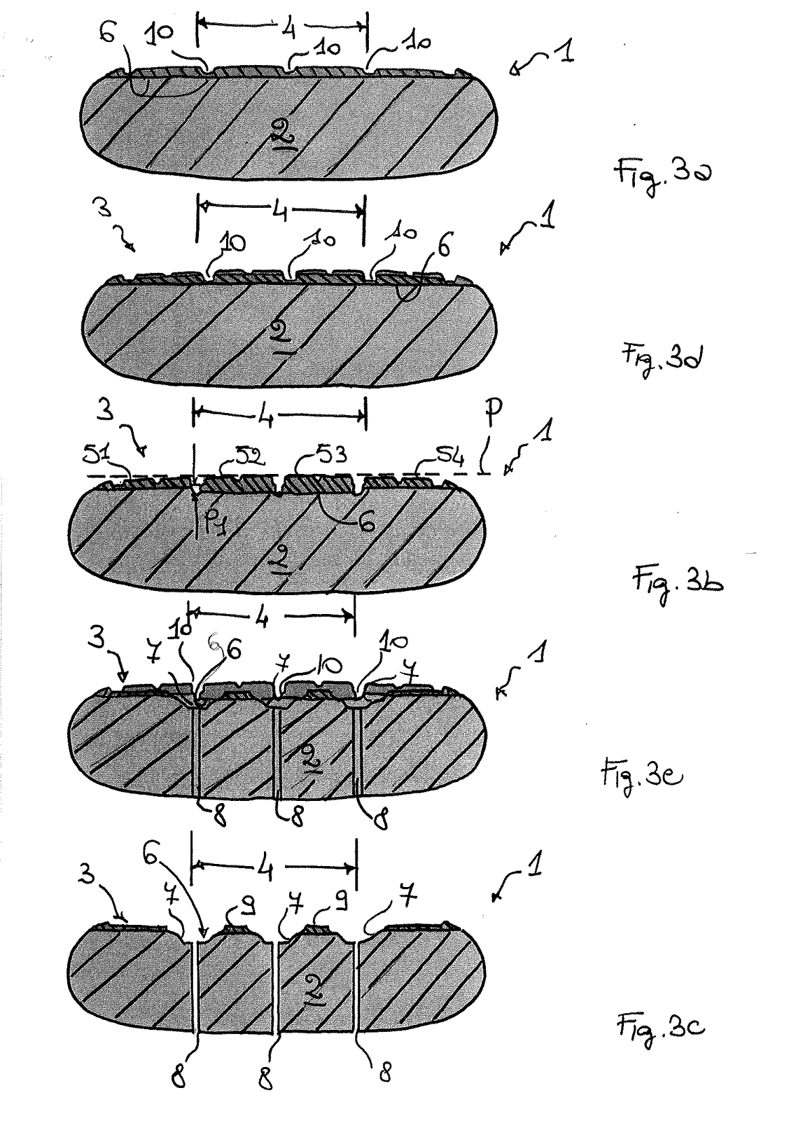

FIGS. 2 and 2a, on the other hand, provide a representation of a support element according to a second embodiment of the present invention.

Such a support element 1 is shaped like a topper and comprises a base layer 2 supporting a plurality of gel inserts 5 arranged a certain distance apart from one another, substantially to cover the entire support face 3.

In this second embodiment of the support element according to the invention, the resting portion 4 is substantially central.

In a version of such an embodiment, the resting portion 4 engages substantially the entire support face 3, with the exception of a perimeter segment.

The resting portion 4 is foreseen to bear, in use, an external force of greater intensity than that foreseen at the other portions of said base layer 2 (perimeter portion), i.e. the weight force of a person laying on the support element (topper).

At the central resting portion 4, in the base layer 2 a housing seat 6 is formed for a plurality of gel inserts 5 (in FIG. 2a indicated with reference numerals 52, 53, 54, 55, 56). In the example depicted, other gel inserts are also foreseen outside of the resting portion 4, indicated, again in FIG. 2a, with reference numerals 51 and 57. So, according to the invention, the gel inserts from 52 to 56, at the central resting portion 4 of the base layer 2, each have a greater average thickness than that of the gel elements 51 and 57 outside the resting portion 4, i.e. arranged on the topper in perimetric position.

In the specific example illustrated, each gel element has a non-constant thickness. Those skilled in the art can, nevertheless, easily appreciate that other configurations, for example having constant thickness, of each gel insert 5 are possible, provided that at the resting portion 4 the average thickness of each gel insert 5 is greater than the average thickness of each gel insert 5 outside of such a portion 4.

The housing seat 6 is formed in the base layer 2 in bas-relief and thus being recessed for a segment P1 in the layer itself. The bottom of the housing seat 6 can comprise a substantially flat surface. Optionally, in the support element 1 according to the second embodiment of the invention, between one insert and the other, it is possible to form through openings that extend between the support face 3 of the base layer 2 and the face opposite thereto, i.e. the face of the support element 1 that is lower in use.

FIGS. 3 to 3e give a representation of a support element 1 according to a third embodiment of the present invention.

Such a support element 1 is shaped like a conventional pillow and comprises a base layer 2 supporting a plurality of gel inserts 5 arranged a certain distance apart from one another, to substantially cover the entire support face 3 of the base layer 2.

In this third embodiment of the support element 1 according to the invention the resting portion 4 is substantially central and substantially engages the entire support face 3, with the exception of a perimeter portion. The resting portion 4 is foreseen to bear, in use, an external force of greater intensity than that foreseen outside of such a resting portion 4 of the base layer 2, i.e. the weight force of a user's head resting on the support element (pillow).

At the central resting portion 4, in the base layer 2 a housing seat 6 is formed for the gel inserts 5, which have various configurations. In the example shown, for example, the gel inserts 5 are foreseen in a number such as to also cover a portion of the base layer 2 outside the resting portion 4. With reference to FIG. 3b, the inserts that are foreseen in the resting portion 4 of the base layer 2 are indicated with reference numerals 52 and 53 and the inserts arranged outside such a portion are indicated with reference numerals 51 and 54. So, according to the invention, the gel inserts 52 and 53, at the central resting portion 4 of the base layer 2, are provided with a greater average thickness than that of the inserts 51 and 54 arranged outside such a resting portion. More specifically, as can be seen from FIGS. 3d and 3e, the average thickness of the gel inserts is greater close to the centre C of the resting portion 4 and decreases along one longitudinal L and transverse T direction with respect to such a centre C.

So, also for this embodiment the consideration applies that those skilled in the art can easily appreciate how various configurations of each gel insert 5 are possible, provided that at the resting portion 4, the average thickness of such a gel insert is greater than the average thickness of the gel insert outside that resting portion 4.

The housing seat 6, like in the other cases, is formed in the base layer 2 in bas-relief and thus is recessed for a segment P1 in the layer itself. In this case, as can be seen from the attached figures, each gel insert extends away from the plane of the housing seat 6 for a segment greater than segment P1, so that it projects with respect to the seat 6. The contact surface, in use, with a user, has substantially a roughly flat or slightly convex shape (illustrated in FIG. 3b with reference letter P), thereby making the pillow very comfortable.

The bottom of the housing seat 6 can comprise a substantially flat surface, possibly equipped with at least one local depression 7 (FIGS. 3b and 3e).

More specifically, the support element according to the third embodiment of the present invention has a plurality of depressions 7, each foreseen in a segment of the base layer 2 or of the housing seat 6 that separates at least two gel inserts 5 from one another. In such a space there is, therefore, an absence of gel. At one or more of such depressions 7 a respective through opening 8 is formed between the support face 3 of the base layer 2 and the face opposite such a support face 3, i.e. a face of the support element 1 according to the invention that is lower in use.

The support element according to the third embodiment of the invention also comprises gel connection segments 9 (see FIG. 3c), intended to connect together the numerous gel inserts 5 to form, if desired, a single body or insert, in the technical jargon also called “pizza”. It is also possible to foresee a single perimeter edge, intended to contain between them the inserts foreseen perimetrically, outside the resting portion 4. As can be seen, in a totally general manner, the support element 1 according to the invention can comprise one or more gel connection segments 9 between at least two gel inserts, so that they form a single insert with each other.

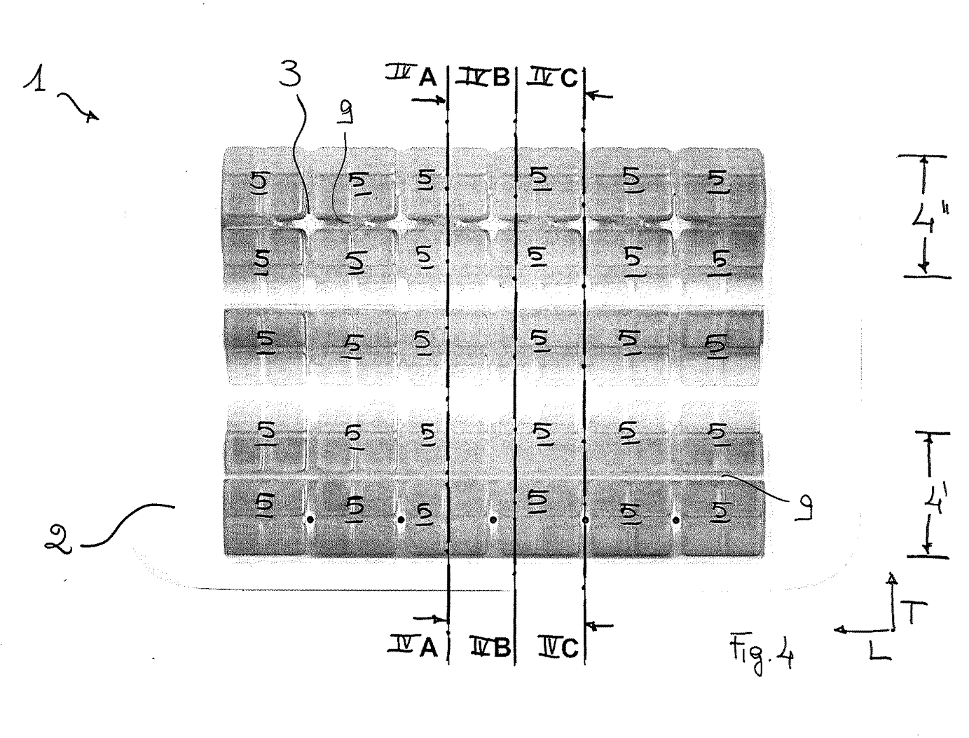

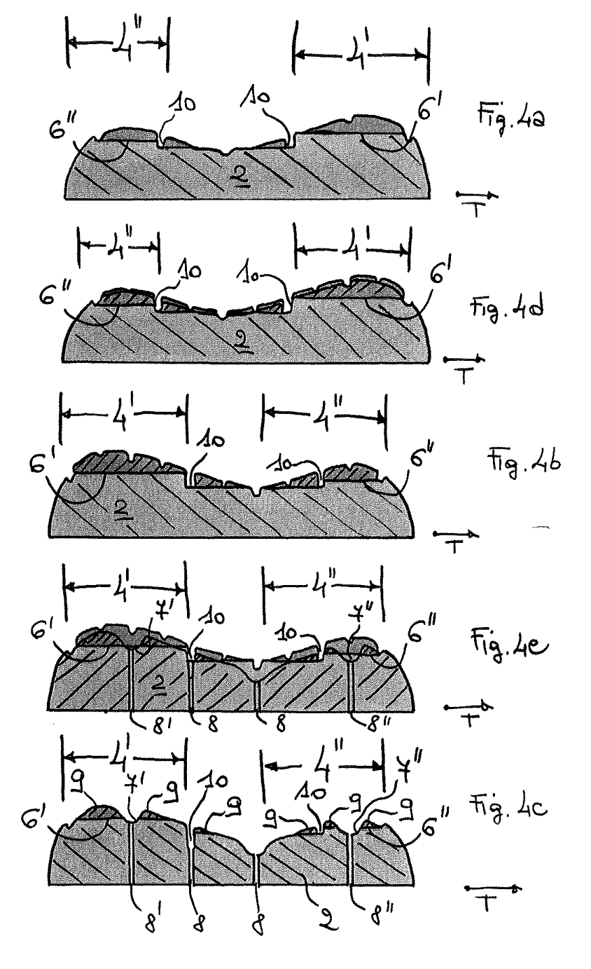

FIGS. 4 to 4d illustrate a representation of a support element 1 according to a fourth embodiment of the present invention.

Such a support element 1 is shaped like an anatomical pillow and comprises a base layer 2 supporting a plurality of gel inserts 5 which inserts are supported by the base layer 2 a short distance from one another, to cover most of the support face 3 of the base layer itself.

In this fourth embodiment of the support element 1 according to the invention the resting portion 4 is a peripheral portion of the base layer, more specifically it is a perimeter portion that extends along a substantially longitudinal direction L of the base layer 2. In this specific case the resting portion 4 comprises the two peripheral segments of the anatomical pillow that extends along the longitudinal direction L. In FIG. 4, the two segments are indicated with reference numerals 4′ and 4″.

Each resting portion 4′, 4″ of the base layer 2 is foreseen to bear, in use, an external force of greater intensity than that foreseen outside of such a resting portion 4′, 4″, i.e. the weight force of the shoulders and neck of a user resting his head on the support element (anatomical pillow).

At the resting portion 4′, 4″, in the base layer 2 at least one housing seat is formed, which will be discussed hereafter, for the plurality of gel inserts 5. In the example shown, the gel inserts 5 also cover a portion of the base layer 2 outside the resting portion 4, in this specific case a central portion. So, according to the invention, the gel inserts 5 at each resting portion 4′, 4″ of the base layer 2, are provided with a greater average thickness than the average thickness of the gel inserts 5 arranged outside such a resting portion. More specifically, as can be seen from FIGS. 4d and 4e, the average thickness of the gel inserts 5, in the resting portions 4′, 4″ can be greater close to a transverse symmetry axis of the support element 1 and progressively decrease along a longitudinal direction L.

Also for this embodiment, the consideration applies that those skilled in the art can easily appreciate that various configurations of each gel insert 5 are possible, provided that at the resting portions 4′, 4″, the average thickness of such a gel insert is greater than the average thickness of the gel insert outside such resting portions 4′, 4″. In the present embodiment, at the resting portions 4′, 4″ respective housing seats 6′, 6″ are provided for the plurality of gel inserts 5. Each housing seat 6′, 6″ is substantially flat and provided with at least one local depression 7′, 7″ (see in particular FIGS. 4b, 4c and 4e).

More specifically, the support element according to the fourth embodiment of the present invention has a plurality of depressions 7′, 7″, each foreseen in the base layer 2 of the at least one housing seat 6′, 6″ comprised in the space that separates at least two gel inserts 5 from each other. In such a space, therefore, there is an absence of gel. At one or more of such depressions 7′, 7″ a respective through opening 8′, 8″ is formed between the support face 3 of the base layer 2 and the face opposite such a support face 3, i.e. a face of the support element 1 according to the invention that is lower in use.

With particular reference to the support face 3, it should be noted how it has an undulating profile in segments and, more specifically, it comprises a substantially flat central segment comprised between two segments, also substantially flat, but of greater (predetermined) height with respect to the face of the support element 1 that is lower during use. With such a configuration, the support face 3 of the base layer 2 has an overall concave central portion.

The base layer 2 of the support element 1 according to the fourth embodiment of the invention thus has a cross section with the segments at the resting portions 4′, 4″ having greater thickness than the central segment of such a cross section.

At the resting portions 4′ and 4″, as well as outside such portions, the gel inserts 5 have a curved profile, so that, globally, the support element 1 according to the invention has a face for making contact with a user in use, comprising a concave central segment that extends along the longitudinal direction L between two convex segments, parallel to it.

So, the support element 1 according to the fourth embodiment of the invention can also comprise gel connection segments 9 (see FIG. 4c), intended to connect together the various gel inserts 5 to form, if so desired, a single body or insert.

With reference to FIGS. 2 to 4d, it will be noted that in the support element 1 according to the invention at least one longitudinal channel 10 and/or a transverse channel 11 can be delimited between the gel inserts 5 to promote air circulation. Moreover, each gel insert 5 has, at a surface thereof opposite to a contact surface with the base layer 2, i.e. a surface that is upper in use, one or more longitudinal and/or transverse recesses 12, to facilitate air circulation. In this case, the surface of the support element 1 according to the invention is, therefore, irregular.

The support element according to the present invention comprises at least one coating layer or film 13, on top of the gel inserts 5 and of support face 3 of the base layer 2 not affected by such inserts, in order to provide an anti-adhesive layer that does not interfere with the movement of a user on the support element. The coating layer or film 13 also keeps the support element 1 cleaner.

Such a coating layer or film 13 is substantially continuous on the surface of the support element that is upper in use and optionally has through openings only in the case in which the through openings 8 described above are formed in the base layer 2 of the support element 1. In this case, the through openings in the coating layer or film 13 have a configuration in cross section substantially corresponding to the configuration in cross section of the top of such through openings 8, i.e., at the support face 3.

So, the support element 1 according to the present invention can be obtained according to a moulding method that is very simple and reliable. Such a method comprises a step of providing a coating layer or film 13, a certain amount of gel intended to form the gel inserts 5, a certain amount of material suitable for constituting the base layer 2 and a mould.

More specifically, the method foreseen to provide a coating layer or film 13 in a mould by inserting or spraying such a coating layer or film 13 into/onto it. The coating layer or film 13 is foreseen to adhere to the surface of the mould and this can take place by vacuum thermoforming the layer or film 13 or in any other suitable way, provided that the layer or film 13 adheres to the mould itself, taking on a shape corresponding to that of the surface of the mould.

The mould is, for this purpose, equipped with terraces and/or bulkheads capable of giving the surface of the mould itself a configuration complementary to that of the upper, in use, surface of the support element 1 according to the invention and in accordance with the arrangement of the gel inserts 5 in the support element 1. The mould is also equipped with shaped elements intended to obtain depressions 7, if foreseen, in the sustaining surface 3 of the base layer 2.

A method according to the present invention also requires a step of casting the gel material on the coating layer or film 13 or part thereof. Such casting takes place through conventional technologies suitable for the purpose. As is obvious, the gel cast in the mould for this purpose equipped with the aforementioned terraces and the aforementioned bulkheads, as well as the aforementioned shaped elements, will be arranged as described above, i.e., to form at least one gel insert 5 of greater average thickness, at a resting portion 4 foreseen for the support element 1 that will be moulded. The bulkheads, the terraces and the shaped elements will possibly also be configured to make the connection segments 9 between the gel inserts and/or a perimeter connection edge between them.

Thereafter there is a step in which the gel hardens and becomes more compact, so as to form the gel inserts 5 and, if foreseen, the connection segments 9 between the inserts and/or a perimeter connection edge between the inserts.

Thereafter, possibly when the gel has not yet totally hardened, a step is foreseen of casting into the mould also a suitable material, for example a polyurethane foam, to form the base layer 2 of the support element 1. Such casting covers the gel previously cast and meanwhile hardened and the coating layer or film 13 not already covered by the gel.

The method thus foresees a step in which the material of the base layer 2 hardens, compacting. The material of the base layer 2, a polyurethane foam, together with the gel and the coating layer or film 13 forms a single body.

Once the base layer has hardened, the support element 1 thus obtained can be extracted from the mould and worked some more. For example, the through openings formed in the base layer 2 can be obtained by punching or in any other suitable way.

According to a variant of the method described above, the gel material intended to form the gel inserts 5 can be made separately in a first mould, to form a so-called “pizza” provided with its own coating layer or film 13 and then inserted on the bottom of a second mould with the coating layer or film 13 for the casting step of the material suitable for forming the base layer 2 of the support element 1.

The method for moulding a support element 1 according to the invention also foresees a step of trimming the support element itself in order to give it the desired dimensions.

It can be seen how the method according to the present invention is simple and made up of a limited number of steps, so as to cut the production time and relative costs.

It has thus been seen how the invention achieves the proposed purposes, providing a support of adequate comfort for a user whilst still limiting as much as possible the amount of gel comprised in the support element itself, since the gel has a greater average thickness only where it is needed. The weight of the support element is thus reduced.

Moreover, a reduction in production costs is also achieved, due to the smaller amount of gel needed with respect to conventional support elements. Therefore, the production costs and the consumption of material are optimised, whilst still providing suitable support and comfort for a user.

A support element according to the present principles and a method for manufacturing the same described above can undergo numerous modifications and variants within the scope of protection of the following claims.

Thus, for example, also in the support element according to the first and the second embodiment of the present invention it is possible to make one or more depressions 7, in a segment of the base layer 2 or of the housing seat 6 that separates at least two gel inserts 5 from one another. In such a segment there is, therefore, an absence of gel. At one or more of such depressions 7 it is possible to form, if so desired, a respective through opening 8 between the support face 3 of the base layer 2 and the face opposite such a support face 3, i.e. a face of the support element 1 according to the invention that is lower during use.

1. A support element for the manufacturing of pillows, mattresses, toppers and the like, comprising:
at least one base layer having at least one upper in use support face, and at least one resting portion;
a plurality of gel inserts supported by said at least one support face of said at least one base layer, spaced from one another;
at least one coating layer or film applied on top of said plurality of gel inserts and said support face not affected by said plurality of gel inserts,
wherein
at said at least one resting portion, each gel insert of said plurality of gel inserts has an average thickness greater than the average thickness of each gel insert of said plurality of gel inserts provided externally to said at least one resting portion.

2. The support element according to claim 1, wherein said resting portion is a central portion of said at least one base layer.

3. The support element according to claim 1, wherein in said at least one base layer, at said at least one resting portion, a housing seat is formed for said at least one gel insert of said plurality of gel inserts having greater average thickness.

4. The support element according to claim 3, wherein said housing seat is a bas-relief surface of said base layer.

5. The support element according to claim 4, wherein said bas-relief surface is substantially flat.

6. The support element according to claim 4, wherein said bas-relief area has at least one depression in the space separating at least two gel inserts of said plurality of gel inserts from one another.

7. The support element according to claim 6, wherein at least one through opening is formed between said at least one support face and said at least one face opposite to said support face, at said at least one depression.

8. The support element according to claim 6, wherein said at least one base layer extends along at least a longitudinal direction (L) and a transverse direction (T), said at least one resting portion has a center (C) and said average thickness of each gel insert of said plurality of gel inserts is greater in proximity of said center (C), and decreases along both a longitudinal (L) and a transverse (T) direction away from said center (C).

9. The support element according to claim 4, wherein said bas-relief area is substantially concave.

10. The support element according to claim 9, wherein, in said housing seat, each gel insert of said plurality of gel inserts has a constant thickness.

11. The support element according to claim 9, wherein each gel insert delimits with said base layer a continuous surface for contacting, in use, a user.

12. The support element according to claim 1, wherein said resting portion is a peripheral perimetral portion of said at least one base layer that extends substantially along at least a longitudinal direction (L) of said base layer.

13. The support element according to claim 12, wherein said at least one base layer has a cross-section having a portion, at said at least one resting portion, of a thickness greater than the thickness of a central portion of said cross-section.

14. The support element according to claim 13, wherein said portion of greater thickness comprises at least one depression comprised in a portion of said base layer which separates at least two gel inserts of said plurality of gel inserts from one another.

15. The support element according to claim 14, wherein at least one through opening is formed at said at least one depression between said at least one support face and said at least one face opposite to said support face.

16. The support element according to claim 12, wherein each gel insert delimits an irregular surface with said at least one support face of said base layer.

17. The support element according to claim 16, wherein within each gel insert at least one longitudinal channel and/or one transverse channel remains delimited to enhance the circulation of air.

18. The support element according to claim 16, in which each gel insert has, at one surface thereof opposite to a contact surface of said at least one base layer, one or more longitudinal and/or transverse recesses in order to enhance the circulation of air.

19. The support element according to claim 12, wherein said at least one base layer extends along at least a longitudinal direction (L) and a transverse direction (T) and each gel insert has an average thickness greater at a transverse symmetry axis of said base layer and decreasing along said longitudinal direction (L).

20. The support element according to claim 1, further comprising at least one coating layer or film at said at least one support face of said at least one base layer and the surface of each gel insert opposite to said at least one base layer.

21. The support element according to claim 1, further comprising at least one connection portion made of gel, intended to mutually connect at least two gel inserts of said plurality of gel inserts, so that they form a single insert therebetween.

22. A method of molding a support element according to claim 1, comprising the steps of:
providing at least one coating layer or film, a certain amount of gel intended to form each gel insert, a certain amount of material adapted to form said at least one base layer;
providing at least one mold equipped with terraces and/or bulkheads and/or shaped parts capable of conferring to the surface of said mold a configuration complementary to that of a top surface, in use, of said support element as well as according to the arrangement of each gel insert and of said depressions, if provided, in said support surface of said at least one base layer;
applying said at least one coating layer or film in said at least one mold so that it adheres to the surface of said mold;
casting said at least a certain amount of gel on said at least one coating layer or film or on a part thereof;
achieving an at least partial curing of said at least a certain amount of gel in order to obtain each gel insert;
casting in said at least one mold said at least a certain amount of material adapted to form said at least one base layer of said support element;
achieving the curing of said at least a certain amount of material adapted to form said at least one base layer.

23. The method of molding a support element according to claim 1, comprising the steps of:
providing at least one coating layer or film, at least a certain amount of gel intended to form each gel insert, at least a certain amount of material adapted to form said at least one base layer, at least one first and at least one second mold, each provided with terraces and/or bulkheads and/or shaped parts capable of conferring to the surface of the respective mold a configuration complementary to that of a top surface, in use, of said support element and/or according to the configuration of each gel insert and of said depressions, if provided, in said support surface of said at least one base layer;
providing said at least one first mold and
applying said at least one coating layer or film in said at least one first mold, so that it adheres to the surface of said mold;
casting said at least a certain amount of gel onto said at least one coating layer or film or on a part thereof; and
achieving the at least partial curing of said at least a certain amount of gel in order to obtain each gel insert;
extracting said at least one coating layer or film on which each gel insert is formed;
providing said at least one second mold and laying down said at least one coating layer or film on the bottom of said second mold, with each gel insert facing upward;
casting in said at least one second mold, said at least a certain amount of material adapted to form said at least one base layer of said support element;
achieving the curing of said at least a certain amount of material adapted to form said at least one base layer.

24. The method according to claim 22, comprising a step of obtaining said through openings by means of punching of said base layer at said support face between at least two gel inserts.
